(19) United States
(12) Patent Application Publication
(10) Pub. No.: US 2016/0071063 A1
(43) Pub. Date: Mar. 10, 2016

(54) ATTENDANCE SYSTEM AND METHOD

(71) Applicants: Fu Tai Hua Industry (Shenzhen) Co., Ltd., Shenzhen (CN); Hon Hai Precision Industry Co., Ltd., New Taipei (TW)

(72) Inventors: ZONG-YUAN SUN, New Taipei (TW); DA-HUA XIAO, Shenzhen (CN)

(21) Appl. No.: 14/587,786

(22) Filed: Dec. 31, 2014

(30) Foreign Application Priority Data
Sep. 10, 2014 (CN) 201410457068.2

(51) Int. Cl. G06Q 10/10; G06Q 40/00

(52) U.S. Cl. CPC G06Q 10/1091; G06Q 40/125

(57) ABSTRACT

An attendance system includes an attendance machine, a server, and a terminal device. The server pre-stores an acknowledgment (ACK) message. The terminal device includes an information processing unit, a first radio frequency (RF) unit, and a second RF unit. The information processing unit stores an identification number corresponding to the ACK message. The first RF unit and the second RF unit communicate with the attendance machine. The first RF unit and the second RF unit selectively sends the identification number to the attendance machine, the attendance machine searches the ACK message in the server and obtains an attendance recording according to the identification number, and the attendance machine feeds back the attendance recording and the ACK message to the terminal device.

### FIELD

The subject matter herein generally relates to attendance systems and methods.

### BACKGROUND

Employees typically record time in a paper format (i.e., paper timesheets) or by clocking in/out using a paper/time attendance machine. However, this method may be inaccurate and time waste.

### BRIEF DESCRIPTION OF THE DRAWINGS

Implementations of the present technology will now be described, by way of example only, with reference to the attached figures.

FIG. 1 is a block diagram of an attendance system employing a terminal device, according to an exemplary embodiment.

FIG. 2 is a first portion of a flowchart of one embodiment of an attendance method using the attendance system of FIG. 1.

FIG. 3 is a second portion of the flowchart of the attendance method of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to an attendance system and method.

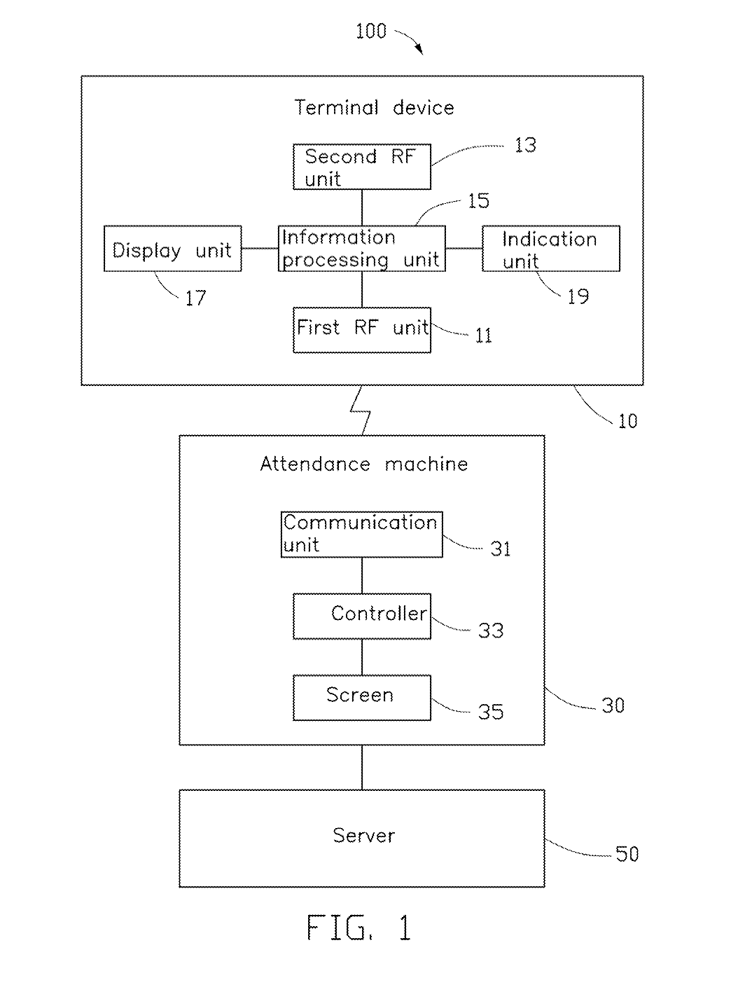

FIG. 1 illustrates an embodiment of an attendance system 100. The attendance system 100 includes a terminal device 10, an attendance machine 30, and a server 50.

The terminal device 10 can be an intelligent magnetic card, a smartphone, a personal digital assistant (PDA), or other devices which can be used to send an identification number of a user and display an attendance recording of the user. In detail, the terminal device 10 includes a first radio frequency (RF) unit 11, a second RF unit 13, an information processing unit 15, a display unit 17, and an indication unit 19. The information processing unit 15 is electronically coupled to the first RF unit 11, the second RF unit 13, the display unit 17, and the indication unit 19.

Both the first RF unit 11 and the second RF unit 13 are configured to send the identification number to the attendance machine 30 and receive the attendance recording and an acknowledgment (ACK) message from the attendance machine 30. The first RF unit 11 is a remote transmission unit and operates at about 2.4 GHz. In at least one embodiment, a radiation radius of the first RF unit 11 can be about 100 meters. The second RF unit 13 is a near field communication (NFC) unit and operates at about 13.56 GHz. Obviously, a radiation radius of the second RF unit 12 is less than the radiation radius of the first RF unit 11. The information processing unit 15 is configured to store the identification number, and the identification number corresponds to the ACK message pre-stored in the server 50. In addition, the information processing unit 15 is configured to transmit the attendance recording and the ACK message from the first RF unit 11 and the second RF unit 13 to the display unit 17. In at least one embodiment, the display unit 17 can be a touch screen to facilitate displaying and inquiring the attendance recording and the ACK message. The indicating unit 19 can be a buzzer or a light emitting diode (LED). When the first RF unit 11 or the second RF unit 13 receives the attendance recording and the ACK message from the attendance machine 30, the information processing unit 15 enables the indicating unit 19.

The attendance machine 30 includes a communication unit 31, a controller 33, and a screen 35. Both the communication unit 31 and the screen 35 are electronically coupled to the controller 33. The communication unit 31 is configured to receive the identification number from the terminal device 10 and transmit the attendance recording and the ACK message to the terminal device 10. In at least one embodiment, the communication unit 31 operates at 13.56 MHz and 2.4 GHz, and consequently communicates with the first RF unit 11 and the second RF unit 13. The controller 33 is electronically coupled to the server 50 to search the ACK message pre-stored in the server 50 according to the identification number, the ACK message may at least include an employee name and a department of the employee. In addition, the controller 33 records an attendance time when the communication unit 31 receives the identification number from the terminal device 10, and then the controller 33 compares the attendance time with a predetermined time to obtain the attendance recording for indicating whether or not the attendance of the employee is normal. For example, if the attendance time exceeds the predetermined time, the attendance recording may be recorded as “be late for work”. Further, the attendance recording and the ACK message can be displayed on the screen 35, and the attendance recording can be further stored in the server 50.

Optionally, the first RF unit 11 can be activated by manually manipulating. Thus, the terminal device 10 communicating with the communication unit 31 via either the first RF unit 11 or the second RF unit 13 can be pre-set based on user's requirements. In other embodiments, the terminal device 10 can enter a sleep mode to conserve power when the terminal device 10 receives the ACK message and the attendance recording from the attendance machine 30.

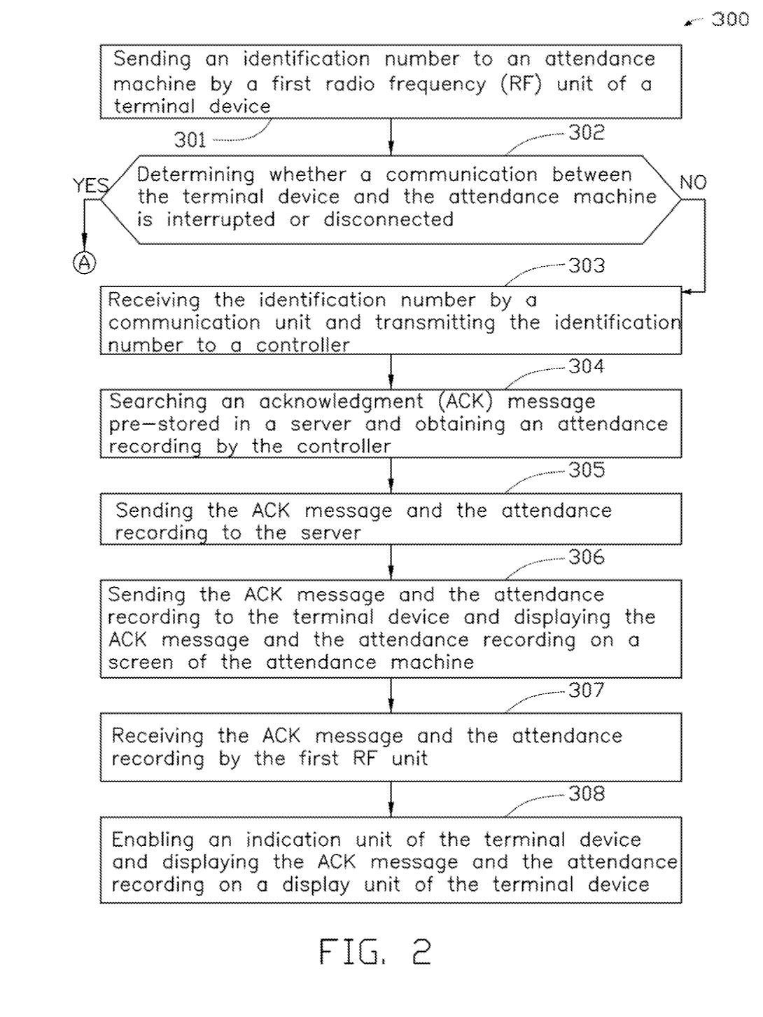

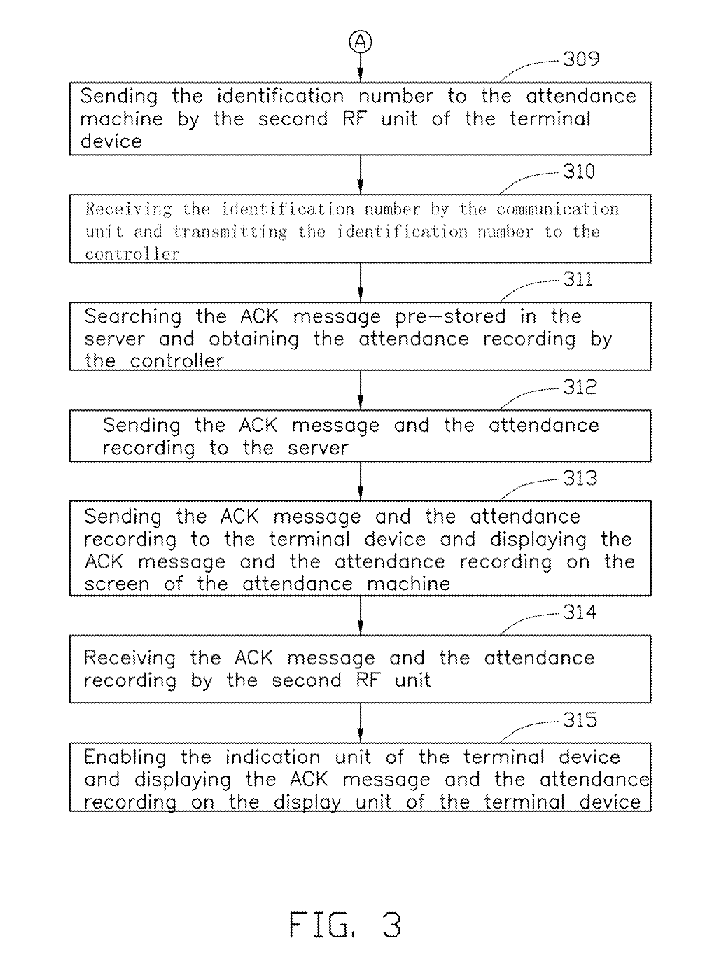

FIG. 2 illustrates a first portion of a flowchart of an example attendance method 300 of the disclosure, and FIG. 3 illustrates a second portion of the flowchart of the example attendance method 300. The attendance method 300 is provided by way of example, as there are a variety of ways to carry out the attendance method 300. The attendance method 300 described below can be carried out using the functional units of the attendance system 100 as illustrated in FIG. 1, for example, and various elements of this figure are referenced in explaining the example attendance method 300. Each block shown in FIG. 2 and FIG. 3 represents one or more processes, methods, or subroutines which are carried out in the example attendance method 300. Furthermore, the order of blocks is illustrative only and the order of the blocks can change. Additional blocks can be added or fewer blocks may be utilized without departing from the scope of this disclosure. The example attendance method 300 can begin at block 301.

At block 301, when a distance between a terminal device and an attendance machine is less than a radiation radius of a first RF unit of the terminal device, the first RF unit sends an identification number to the attendance machine.

At block 302, the attendance machine determines whether a communication between the terminal device and the attendance machine is interrupted or disconnected. If the communication between the terminal device and the attendance machine is connected, blocks 303-308 are implemented. If the communication between the terminal device and the attendance machine is interrupted or disconnected, blocks 309-315 are implemented.

At block 303, a communication unit of the attendance machine receives the identification number and transmits the identification number to a controller of the attendance machine.

At block 304, the controller searches an ACK message pre-stored in a server according to the identification number and obtains an attendance recording by comparing a predetermined value with an attendance time indicating that the communication unit receives the identification number from the terminal device.

At block 305, the controller sends the attendance recording to the server to store the attendance recording.

At block 306, a screen of the attendance machine displays the ACK message and the attendance recording, and the communication unit sends the ACK message and the attendance recording to the terminal device.

At block 307, the first RF unit receives the ACK message and the attendance recording.

At block 308, an information processing unit of the terminal device enables an indication unit of the terminal device according to the ACK message and the attendance recording, and the ACK message and the attendance recording are further displayed on a display unit of the terminal device.

At block 309, when a user is close to the attendance machine, a second RF unit of the terminal device may be manually held in close proximity to the attendance machine, and then the second RF unit sends the identification number to the attendance machine.

At block 310, the communication unit of the attendance machine receives the identification number and transmits the identification number to the controller of the attendance machine.

At block 311, the controller searches the ACK message pre-stored in the server according to the identification number and obtains the attendance recording by comparing the predetermined value with the attendance time indicating that the communication unit receives the identification number from the terminal device.

At block 312, the controller sends the attendance recording to the server to store the attendance recording.

At block 313, the screen of the attendance machine displays the ACK message and the attendance recording, and the communication unit sends the ACK message and the attendance recording to the terminal device.

At block 314, the second RF unit receives the ACK message and the attendance recording.

At block 315, the information processing unit of the terminal device enables the indication unit of the terminal device according to the ACK message and the attendance recording, and the ACK message and the attendance recording are further displayed on the display unit of the terminal device.

In summary, the terminal device 10 includes the first RF unit 11 and the second RF unit 13 communicating with the attendance machine 30, thus, two manners can be alternatively adopted by the terminal device 10 to save time. That is, when one of the first RF unit 11 and the second RF unit 13 malfunctions or does not work, another one can be activated to complete the attendance recording process. Thus, the attendance system 100 is both efficient and convenient.

The embodiments shown and described above are only examples. Many details are often found in the art such as the other features of the attendance system and method. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A terminal device in communication with an attendance machine, the terminal device comprising:
an information processing unit storing an identification number;
a first radio frequency (RF) unit communicating with the attendance machine; and
a second RF unit communicating with the attendance machine;
wherein the first RF unit and the second RF unit alternatively sends the identification number to the attendance machine and receives an attendance recording from the attendance machine; and
wherein a radiation radius of the second RF unit is less than a radiation radius of the first RF unit.

2. The terminal device as claimed in claim 1, further comprising a display unit, wherein the attendance recording is displayed on the display unit.

3. The terminal device as claimed in claim 1, further comprising an indicating unit coupled to the information processing unit, wherein the information processing unit enables the indicating unit when the terminal device receives the attendance recording.

4. An attendance system, comprising:
an attendance machine;
a server pre-storing an acknowledgment (ACK) message and communicating with the attendance machine; and
a terminal device comprising:
an information processing unit storing an identification number corresponding to the ACK message;
a first radio frequency (RF) unit communicating with the attendance machine; and
a second RF unit communicating with the attendance machine;
wherein the first RF unit and the second RF unit selectively sends the identification number to the attendance machine, the attendance machine searches the ACK message in the server and obtains an attendance recording according to the identification number, and the attendance machine feeds back the attendance recording and the ACK message to the terminal device.

5. The attendance system as claimed in claim 4, wherein the terminal device further comprises a display unit, wherein the attendance recording and the ACK message are displayed on the display unit.

6. The attendance system as claimed in claim 4, wherein the terminal device further comprises an indicating unit coupled to the information processing unit, wherein the information processing unit enables the indicating unit when the terminal device receives the attendance recording and the ACK message.

7. The attendance system as claimed in claim 4, wherein the attendance machine comprises a communication unit, the communication unit communicates with the first RF unit and the second RF unit to receive the identification number from the terminal device and transmit the attendance recording and the ACK message to the terminal device.

8. The attendance system as claimed in claim 4, wherein the attendance machine comprises a controller electronically connected to the server, the controller searches the ACK message pre-stored in the server.

9. The attendance system as claimed in claim 8, wherein the controller records an attendance time when the communication unit receives the identification number from the terminal device, and compares the attendance time with a predetermined time to obtain the attendance recording.

10. The attendance system as claimed in claim 4, wherein the attendance machine further comprises a screen to display the attendance recording and the ACK message.

11. An attendance method, comprising:
sending, by a first radio frequency (RF) unit of a terminal device, an identification number to an attendance machine when a distance between the terminal device and the attendance machine is less than a radiation radius of a first RF unit of the terminal device;
determining, by the attendance machine, whether a communication between the terminal device and the attendance machine is interrupted or disconnected;
when the communication between the terminal device and the attendance machine is connected, executing steps of:
receiving, by a communication unit of the attendance machine, the identification number, and transmitting the identification number to a controller of the attendance machine;
searching, by the controller, an acknowledgment (ACK) message pre-stored in a server and obtaining an attendance recording by comparing a predetermined value with an attendance time indicating that the communication unit receives the identification number from the terminal device;
sending, by the communication unit, the ACK message and the attendance recording to the terminal device;
receiving, by the first RF unit, the ACK message and the attendance recording;
when the communication between the terminal device and the attendance machine is interrupted or disconnected, executing steps of:
sending, by a second RF unit of the terminal device, the identification number to the attendance machine when the second RF unit is in close proximity to the attendance machine;
receiving, by the communication unit of the attendance machine, the identification number, and transmitting the identification number to the controller of the attendance machine;
searching, by the controller, an acknowledgment (ACK) message pre-stored in the server and obtaining the attendance recording by comparing the predetermined value with the attendance time indicating that the communication unit receives the identification number from the terminal device;
sending, by the communication unit, the ACK message and the attendance recording to the terminal device; and
receiving, by the second RF unit, the ACK message and the attendance recording.

12. The attendance method as claimed in claim 11, further comprising sending, by the controller, the ACK message and the attendance recording to the server.

13. The attendance method as claimed in claim 11, further comprising displaying, by a screen of the attendance machine, the ACK message and the attendance recording.

14. The attendance method as claimed in claim 11, further comprising displaying, by a display unit of the terminal device, the ACK message and the attendance recording.

15. The attendance method as claimed in claim 11, further comprising enabling, by an information processing unit of the terminal device, an indication unit of the terminal device according to the ACK message and the attendance recording.
